(19) United States
(12) Patent Application Publication
(10) Pub. No.: US 2021/0274780 A1
(43) Pub. Date: Sep. 9, 2021

(54) Disinfectant Composition Against the Novel Wuhan Corona Virus COVID-19

(71) Applicant: Sarfaraz K. Niazi, Deerfield, IL (US)

(72) Inventor: Sarfaraz K. Niazi, Deerfield, IL (US)

(21) Appl. No.: 16/811,971

(22) Filed: Mar. 6, 2020

(51) Int. Cl. A01N 33/12; A01N 31/02; A01N 61/02

(52) U.S. Cl. CPC A01N 33/12; A01N 61/02; A01N 31/02

(57) ABSTRACT

Liquid disinfectant capable of instantly inactivating Wuhan Coronavirus COVID-19 comprising a plurality of chemical and natural disinfectants in an ethanol and propanol mixture is disclosed with ability to instantly kill the virus completely upon contact.

### BACKGROUND OF THE INVENTION

Virus epidemics are responsible for millions of deaths throughout the history of humankind, including in most recent years, the SARS, Ebola, and Coronavirus, including the novel Coronavirus SARS-CoV-2, the Cause of COVID-19. The coronavirus is a mutated virus, and to date, there has been no means of eradicating it from contact surfaces, most notably from hand, to prevent its spread without using an effective disinfectant. There is a dire unmet need for a disinfectant composition that will kill all viruses, including the coronavirus, upon immediate contact.

Hand sanitizer is a liquid generally used to decrease infectious agents on the hands. Formulations of the alcohol-based type are preferable to handwashing with soap and water in most situations in the healthcare setting. It is generally more effective at killing microorganisms and better tolerated than soap and water. Alcohol has been used as an antiseptic at least as early as 1363 with evidence to support its use becoming available in the late 1800s. Alcohol-based hand sanitizer is used in Europe since at least the 1980s. The alcohol-based version is on the World Health Organization's List of Essential Medicines. Alcohol-based versions typically contain some combination of isopropyl alcohol, ethanol, or n-propanol. Alcohol-based hand sanitizer works against a variety of microorganisms but not spores since the primary mechanism of alcohol is to crenate and dehydrate the living organisms to death. Some versions contain compounds such as glycerol to prevent drying of the skin. The alcohol in hand sanitizers may not have the 10-15 seconds exposure time required to denature proteins and lyse cells in too low quantities (0.3 ml) or concentrations (below 60%). In environments with high lipids or protein waste (such as food processing), the use of alcohol hand rubs alone is not sufficient to ensure proper hand hygiene.

In addition to alcohol (ethanol, 1-propanol, 2-propanol), hand sanitizers also contain additional antiseptics such as chlorhexidine and quaternary ammonium derivatives, sporicides such as hydrogen peroxides that eliminate bacterial spores, emollients, and gelling agents to reduce skin dryness and irritation, and foaming agents, colorants or fragrances. The World Health Organization recommends a combination of ethanol, hydrogen peroxide, and glycerol as an effective antiseptic disinfectant solution.

While there are several options available to eradicate microbes and viruses, their effectiveness is limited by the latency of effectiveness and extent of effectiveness. The instant invention provides an effective solution to kill 100% of all viruses upon immediate contact through a process of graduated evaporation, multiple anti-infective, and use of oils from plants that are known to be virus-resistant.

### SUMMARY OF THE INVENTION

The instant invention is a combination of antiseptics and viricidal agents that work synergistically to assure a 100% kill of all viruses, including the coronavirus. Based on alcohol that acts as a dehydrating agent, the quaternary agents that act to break the cell wall and deactivate virus and a natural antiseptic that enhance the action on viruses based on the inherent protective properties of the natural component, the instant invention offers a complete solution to the prevention of the spread of Corona virus.

### DETAILED DESCRIPTION OF THE INVENTION

The present invention to eradicate surface virus, including COVID-9, is based on surprising results obtained based on a combination of both existing and novel anti-infectives in an application base that provides fast contact and wetting of skin, moderated evaporation and instant delivery of anti-infective agents to instantly deactivate all viruses. The traditional time recommended for the use of other such products is not applicable to the instant invention.

The anti-infective agents used have proven effectiveness. Chlorhexidine is active against Gram-positive and Gram-negative organisms, facultative anaerobes, aerobes, and yeasts. It is particularly effective against Gram-positive bacteria (in concentrations ≥1 μg/l). Significantly higher concentrations (10 to more than 73 μg/ml) are required for Gram-negative bacteria and fungi. Chlorhexidine is ineffective against polioviruses and adenoviruses. Chlorhexidine, like other cation-active compounds, remains on the skin. At physiologic pH, chlorhexidine salts dissociate and release the positively charged chlorhexidine cation. The bactericidal effect is a result of the binding of this cationic molecule to negatively charged bacterial cell walls. At low concentrations of chlorhexidine, this results in a bacteriostatic effect; at high concentrations, membrane disruption results in cell death.

Benzalkonium chloride is an organic salt classified as a quaternary ammonium compound. It has three main categories of uses: a biocide, a cationic surfactant, and a phase transfer agent. The mechanism of bactericidal/microbicidal action is thought to be due to the disruption of intermolecular interactions that can cause dissociation of cellular membrane lipid bilayers, which compromises cellular permeability controls and induces leakage of cellular contents. Other biomolecular complexes within the bacterial cell can also undergo dissociation. Benzalkonium chloride solutions are fast-acting biocidal agents with a moderately long duration of action. They are active against bacteria and some viruses, fungi, and protozoa

Anti-infective compounds are widely synthesized by plants and bacteria, mainly to protect them from microbial, fungal, and viral contamination. Coconut oil is easily absorbed into the skin. It is known to have many health benefits, including serving as a source of vitamins E and K, as well as its antifungal and antibacterial properties. Jojoba Oil is native to Mexico and the American Southwest, where its oils have been extracted from its seeds and used medicinally by Native American tribes. Jojoba oil has anti-inflammatory and wound-healing effects, among other skin benefits. Grapeseed oil contains vitamin E and essential fatty acids, and has antioxidant, antimicrobial, and anti-inflammatory properties. One advantage of these oils is that they provide a protective layer on the skin, reducing skin-drying that is common in the use of alcohol-based disinfectants.

Alcohols have been used as a disinfectant for centuries, mainly because of the property of alcohol to dehydrate living cells, causing crenation and cell death. However, alcohols also demonstrate a remarkable property of azeotrope formation when combined with water wherein a better molecular fit reduces the volume, resulting in such differentiations as volume by volume vs. weight by volume; the azeotropes have lower boiling than both the alcohol and water and allow faster evaporation from the surface. The ethanol produced in the distillation process is 95% v/v product with 95.63% alcohol and 4.37% water that is tightly bound and not removed by the distillation process. Isopropyl alcohol or 2-propanol is primarily produced by combining water and propene in a hydration reaction or by hydrogenating acetone. Isopropyl alcohol and water form an azeotrope, and simple distillation gives a material that is 87.9% by weight isopropyl alcohol and 12.1% by weight water. 1-Propanol is manufactured by catalytic hydrogenation of propionaldehyde. The propionaldehyde is itself produced via the oxo process, by hydroformylation of ethylene using carbon monoxide and hydrogen in the presence of a catalyst such as cobalt octacarbonyl or a rhodium complex. A combination of ethanol, 1-propanol, and 2-propanol provides a wide range of solubility characteristics, wetting properties, and a broad range of effectiveness against microbes.

Immediate wetting of a surface upon application of a disinfectant is an important property to make the application effective. The instant invention provides a contact angle of less than 10 degrees providing instant wetting and exposure to the applied surface.

Evaporation of alcohol or drying of a surface is an essential part of applying a disinfectant liquid of enabling normal function. If ethanol alone is used and applied on skin, the evaporation is faster than 2-propanol that is faster than 1-propanol; by combining the three alcohols, a more stable and reduced evaporation is obtained that allows better contact and is responsible for the 100% effectiveness, among many other synergistic effects of the polarity of disinfectants used in the formulation.

The 2019 n-CoV is a betacoronavirus whose mode of spread is not yet fully understood, but contact with contaminated surfaces and/or airborne is highly likely. The minimum requirement for a claim is a pass the efficacy to kill all betacronovirus is EN 14476:2013+A2 2019 or EN 14476: 2013+A1 2015 (hand products) against vaccinia virus (at less than 2 minutes for hand products and less than 5 minutes for surface products). This testing covers all enveloped viruses, including all coronaviruses. The instant invention complies fully with EN 14476: 2013+A2 2019 is less than one minute (the test limit).

While the components of the instant invention are known, their combination in specific proportions resulted in a most surprising result of eliminating all viruses including the novel coronavirus instantly that has not been possible. The claim of instant is made since the test results cannot be validated for a less than one minute response.

In a preferred embodiment, the instant invention is a combination of a plurality of natural and synthetic anti-infective agents in an alcohol-based formulation capable of killing 100% of viruses of all types upon immediate contact.

In another embodiment, the instant invention provides a moderated evaporation to allow longer, more effective contact and a low contact angle to provide better wetting and exposure to all parts of the hand, including nails and other tissues.

In another embodiment, the instant invention can be used as a hand sanitizer as a surface sanitizer for the prevention of the spread of coronavirus.

1-17. (canceled)

18. A disinfectant composition comprising essentially of 31.66% v/v of ethanol, 31.66% v/v of 1-propanol and 31.66% v/v of 2-propanol, 0.02% w/v of benzalkonium chloride, 0.2% w/v of coconut oil and sterile water to make the volume to 100%.

19. The disinfect composition of claims 18, wherein the composition is a hand sanitizer, a surface sanitizer, imbued in a wipe, or a spray.
